(19) United States
(12) Patent Application Publication
(10) Pub. No.: US 2026/0180940 A1
(43) Pub. Date: Jun. 25, 2026

(54) CREATING SENDER ACCOUNTS FOR MESSAGING CHANNELS

(71) Applicant: Twilio Inc., San Francisco, CA (US)

(72) Inventors: Ryan Robert Edward Krueger, San Diego, CA (US); Darryl Anthony Alvares, San Ramon, CA (US); Otavio Elias Dalarossa, San Jose, CA (US); Olivia Ea, Fremont, CA (US); Praveena Johnson, Los Gatos, CA (US); Anson Babu Melakayil, Raleigh, NC (US); Elizabeth Robinson, Portland, OR (US); James Richard Whiteacre, Lone Tree, OR (US); Zhen Zhang, Sunnyvale, CA (US)

(21) Appl. No.: 18/990,876

(22) Filed: Dec. 20, 2024

(51) Int. Cl. H04L 51/046; G06Q 30/01

(52) U.S. Cl. CPC H04L 51/046; G06Q 30/01

(57) ABSTRACT

A communication services platform receives a first request of a customer to configure a sender account associated with at least a first messaging channel of a plurality of messaging channels. A second request to configure the sender account is communicated to the first messaging channel via a first communication channel. The second request comprises an identifier of a communication resource associated with the communication services platform. A verification message is received via a second communication channel associated with the communication resource. The verification message is communicated to the first messaging channel via the first communication channel. The customer is notified of a result of configuring the sender account.

### TECHNICAL FIELD

Aspects and embodiments of the present disclosure relate to communication services, and in particular to creating sender accounts for messaging channels.

### BACKGROUND

Communication services platforms can offer various messaging services to users, such as tools that enable sending and/or receiving bulk messages or messages targeted to individual recipients.

### BRIEF DESCRIPTION OF DRAWINGS

Various embodiments in accordance with the present disclosure will be described with reference to the drawings, in which:

FIG. 1 is a block diagram of an example system architecture for creating sender accounts for messaging channels, in accordance with an embodiment;

FIG. 2 is a block diagram of a communication services platform communicating with messaging channels over a plurality of channels to configure sender accounts, in accordance with an embodiment;

FIG. 3 illustrates a mapping of message platform-specific sender accounts to a uniform sender profile of a communication services platform, in accordance with an embodiment;

FIG. 4 is a flow diagram of an example method for creating sender accounts for messaging channels, in accordance with an embodiment;

FIG. 5 is a block diagram illustrating an example computer system, in accordance with an embodiment.

### DETAILED DESCRIPTION

In various use cases, organizations may employ communication services platforms for various messaging services. In an illustrative example, a communication services platform, such as a Software as a Service (SaaS) platform, may facilitate sending of messages, such as SMS messages, MMS messages, and/or IM messages, to recipient devices via various messaging channels. “Messaging channel” or “communication channel” refers to a medium that uses one or more of a particular protocol, a particular underlying technology or is provided by a particular entity (e.g., third-party entity). Accordingly, a SAAS platform may utilize various messaging channels relying upon one or more communication protocols through which messages may be forwarded to recipient devices. For example, the SaaS platform may use one or more hosted and/or ported telephone numbers to send text messages (e.g., SMS messages) to recipient devices using one or more SMS messaging channels, such as telecommunications carrier networks. In another example, the SaaS platform may send instant messages to recipient devices using one or more IM messaging channels. Examples of messaging channels include mobile network-based channels such as SMS or MMS, Rich Communication Services (RCS) channels (including RCS Business Messaging (RBM)), Internet Protocol (IP)-based channels, voicemail, and proprietary channels (e.g., social media messaging applications). A communication services platform can be a multitenant communication services platform wherein different customers can submit independent requests for messaging services to the multitenant communication services platform, which can fulfill the requests using one or more of various messaging channels available to the multitenant communication services platform.

In order to being able to send messages via a chosen messaging channel, a communication services platform should configure a sender entity specific to the messaging channel. A sender can be a communication endpoint used to send or receive a message and can be dedicated to a single customer or can be shared among multiple customers. For example, for customers sending SMS messages, a communication services platform can configure a 10-digit long code or short code as an originating phone number for the SMS messages. Customers can then employ the communication services platform to send messages on their behalf via the chosen messaging channel(s). Different customers can employ the communication services platform for sending messages using different messaging channels based on various factors. For example, a customer can select or prefer one or more channels based on the cost to send messages, the probability of successful message delivery and/or recipient interaction (e.g., conversion rate), or based on other considerations.

Communication services platforms can face challenges related to creating multiple senders for multiple messaging channels. Each messaging channel can have unique requirements to provision a new sender. For example, one platform can require a customer or communication services platform to create a business account, while a second platform can require a customer or communication services platform to provide detailed know-your-customer (KYC) information. Messaging platforms can have additional platform-specific onboarding requirements before a customer or communication services platform can begin sending and receiving messages with a sender. For example, a messaging platform can require a communication services platform to verify ownership of a phone number or email address by sending a one-time password (OTP) to that phone number or email address. Furthermore, messaging platforms can have varying interfaces for querying metadata about a sender (e.g., status, quality metrics, messaging limits, etc.).

As a result of these challenges, customers and communication services platforms can devote excessive resources (e.g., time, compute, or financial resources) to creating and managing multiple senders with diverse configuration requirements. Furthermore, customers of communication services platforms can be required to communicate directly with messaging platforms during aspects of the sender creation process, which can be burdensome for the customer. Customers of communication services platforms can also be required to perform unique additional steps for each messaging platform to query metadata of each sender (e.g., sender availability, sender quality metrics, etc.) rather than accessing a unified interface for querying metadata.

Aspects of the present disclosure address these and other challenges by employing communication services platforms for creating sender accounts for messaging channels using a common set of customer metadata (e.g., phone number, email address, KYC data) provided by a customer to the communication services platform. In an embodiment, a communication services platform provides to its customers a common sender configuration interface (e.g., API), which a customer can invoke in order to provision one or more senders to be used for forwarding messages via respective one or more messaging channels (supported by respective messaging platforms). The communication services platform can in turn provide a relevant subset of customer metadata to each messaging platform for which the customer has requested to create a sender account. In an embodiment, the communication services platform can forward requests from messaging platforms for additional information (e.g., additional KYC information) to the customer via the common interface.

In an embodiment, a communication services platform provides an identifier of a communication resource of the communication services platform (e.g., a phone number or an email address) to a messaging platform. To verify that the communication services platform owns or controls the communication resource, the messaging platform can send a verification message (e.g., an OTP) to the communication services platform via a communication channel associated with the communication resource, and the communication services platform can provide the verification message back to the messaging platform via the same communication channel or a different communication channel. Thus, the communication services platform can perform a sender configuration without involvement of the customer.

In an embodiment, a communication services platform provides a uniform interface enabling customers to access sender metadata (e.g., sender status, quality metrics, messaging limits, etc.) associated with each messaging platform, which can be used to make decisions about which messaging channel to use for delivering a message or to measure channel characteristics such as conversion rate. For example, the communication services platform can use different interfaces to obtain sender metadata from each messaging platform and forward the sender metadata to customers via a common interface of the communication services platform.

Accordingly, communication services platforms and their customers using the techniques described herein can benefit from a uniform process for creating senders with messaging platforms, which can improve customer experience and reduce resource consumption. Communication services platforms can support a variety of messaging channels with differing schema requirements and different verification processes and can facilitate streamlined messaging operations for customers, enabling customers to reliably scale sender account setup. Communication services platforms can further improve the security, reliability, and efficiency of sender account setup for customers by using secure communication channels with support for retries and acknowledgement-based validation.

The present disclosure addresses the technical problem of creating sender accounts for messaging channels requiring verification messages to be received in a communication channel. A technical solution to the above-identified problem involves providing identifiers of communication resources of a communication services platform to the messaging platforms for receiving the verification messages in the communication channel and providing the verification messages back to the messaging platforms without customer interaction. Thus, the technical effect includes using a communication services platform to create sender accounts for messaging channels, which provides a uniform interface for customers and reduces customer resource consumption.

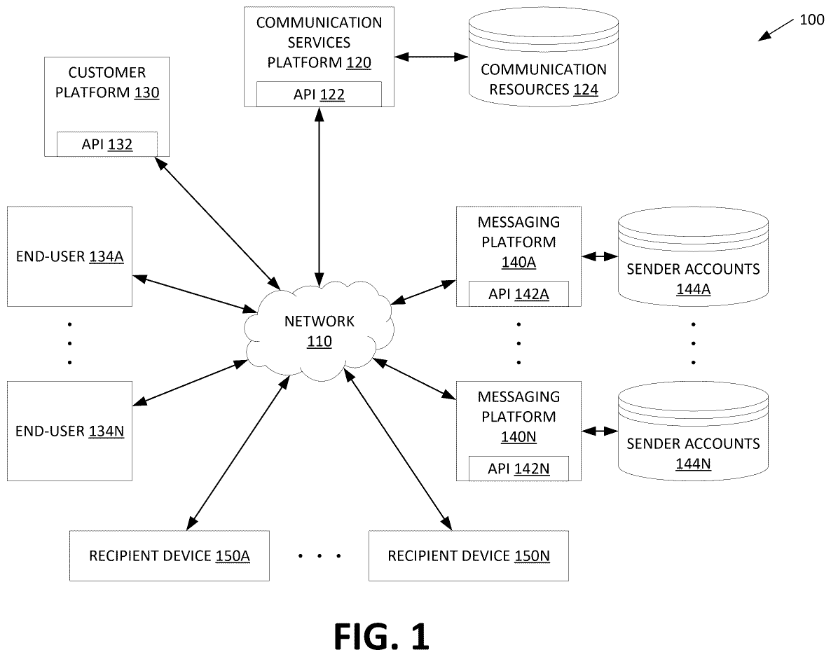

FIG. 1 is a block diagram of an example system architecture 100 for creating sender accounts for messaging channels, in accordance with an embodiment. System architecture 100 (also referred to as “system” herein) includes network 110, communication services platform 120, customer platform 130, end-users 134A-N (e.g., customers of the customers of communication services platform 120), messaging platforms 140A-N associated with respective messaging channels, and recipient devices 150A-N. In various embodiments, system 100 can include more or fewer components in different configurations than those depicted in FIG. 1. For example, system 100 can include additional customer platforms 130 in an embodiment. In another example, end-users 134A-N can be direct customers of communication services platform 120, and customer platform 130 can be absent.

Network 110 can include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. Network 110 or components thereof can be associated with different organizations in various embodiments. For example, components of network 110 can be associated with Internet Service Providers (ISPs), mobile or cellular carriers, cloud platform or software-as-a-service (SaaS) providers, private or public enterprises, private households or communities, etc. In an embodiment, network 110 (or a component thereof) can be a physical or virtual interconnect within a single device, such as a PCIe bus, a messaging system, or an API.

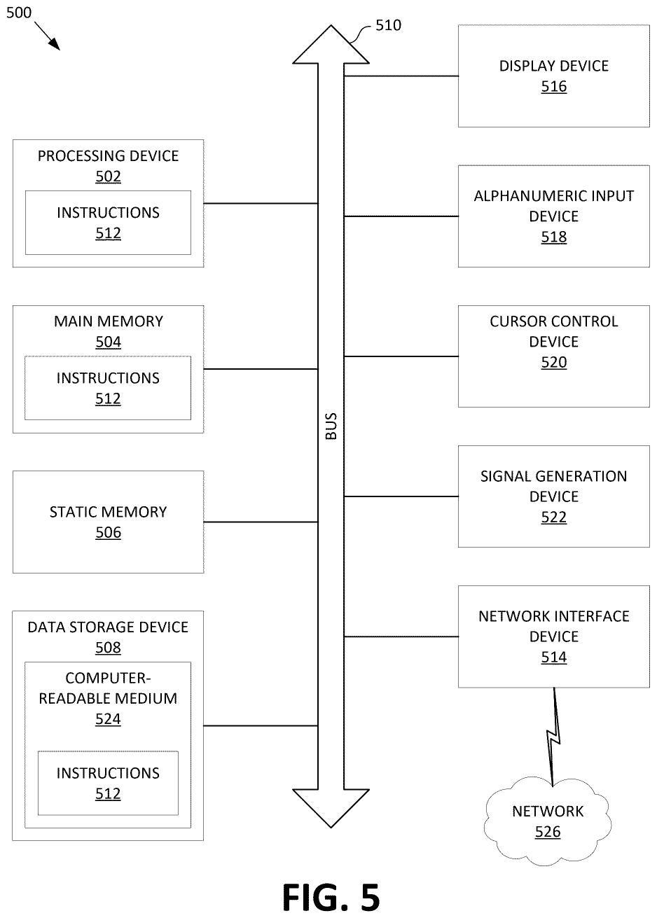

Each of platforms 120 and 130, as well as end users 134A-N, messaging platforms 140A-N, and recipient devices 150A-N can be, can include, or can be included in a personal computer (PC), a laptop computer, a notebook computer, a mobile phone, a smartphone, a tablet computer, a digital assistant, a rackmount server, a router computer, or similar computing device. An example computing device is further described below with reference to FIG. 5. These platforms and devices can also each be a virtualized resource such as a virtual machine (VM) or a containerized application. These platforms and devices can also be a collection of physical or virtual computing resources, such as a datacenter or a collection of servers or VMs distributed across multiple data centers. For example, these platforms and devices can be cloud computing resources provisioned from a cloud computing provider. These platforms and devices can run an operating system or one or more software applications. In an embodiment, the functions described with reference to these platforms and devices can be performed by a single platform/device or additional platforms/devices.

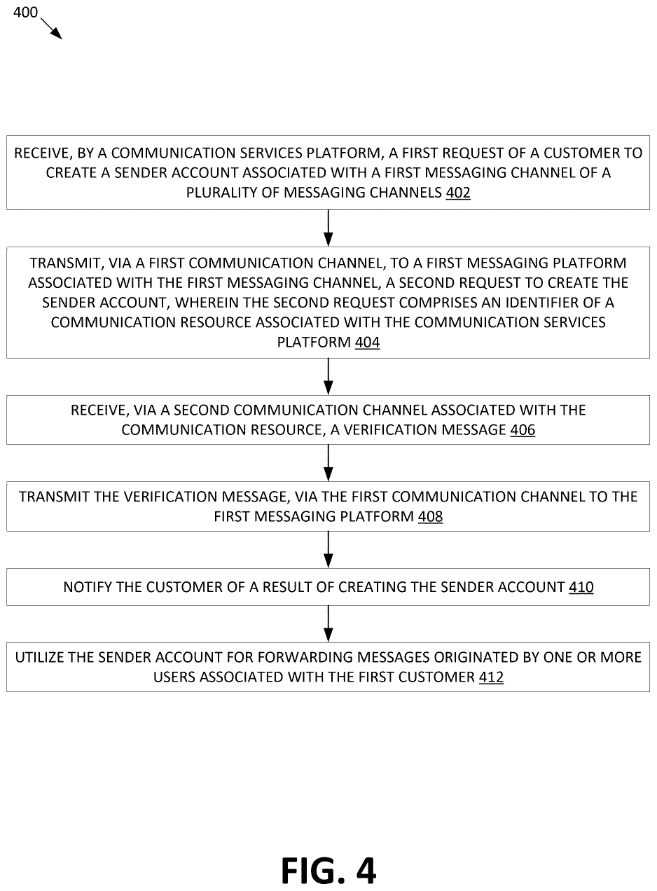

Communication services platform 120 can provide various communication services to customer platforms, their end user platforms, and end users (e.g., recipients) of the above platforms. Communication services provided by communication services platform 120 can include mass distribution of personalized messages for marketing campaigns, informational campaigns, or similar. Communication services platform 120 can also provide sender account creation services for creating sender accounts of messaging channels and/or message provider platforms as described with reference to FIG. 4.

Communication services platform 120 can provide application programming interface (API) 122 for interacting with one or more of the communication services provided by communication services platform 120. A client of communication services platform 120 (e.g., customer platform 130) can call API functions of API 122 using one or more application layer protocols, such as HyperText Transfer Protocol (HTTP) (or HTTP secure (HTTPS)). Communication services platform 120 can respond to API function calls using one or more synchronous or asynchronous API responses on an application layer protocol. Examples of APIs that can be used include a REST (Representational State Transfer) API, a GraphQL API, or a SOAP (Simple Object Access Protocol) API, a gRPC (gRPC Remote Procedure Call) API, among others.

Communication services platform 120 can be associated with one or more communication resources 124. A communication resource can be an endpoint that enables communication services platform 120 to send or receive messages over a communication channel. For example, communication resources 124 can include one or more phone numbers owned by communications services platform 120, one or more email addresses registered by communication services platform 120, one or more instant messaging accounts registered by communication services platform 120, or similar. In an embodiment, communication resources 124 can include a communication resource for accessing resources on a network, such as a resource for accessing URLs on the internet.

Customer platform 130 can be a platform of an entity that provides user-facing software products and/or services. Customer platform 130 can be a customer of communication services platform 120 and can integrate some of the communication services provided by communication services platform 120 into the software products and/or services. For example, customer platform 130 can be a marketing campaign management platform that uses communication services platform 120 to send marketing messages. In another example, customer platform 130 can be a website creation platform that uses communication services platform 120 to send informational messages to website visitors. Customer platform 130 can communicate with communication services platform 120 via API 122. Analogous to API 122, customer platform 130 can provide API 132 for interacting with one or more of the software products/services provided by customer platform 130.

End-users 134A-N can be entities or platforms that communicate with recipients (via recipient devices 150A-N) for various purposes. For example, end-users 134A-N can be retailers or other businesses that conduct marketing campaigns and send marketing messages to recipients. In another example, end-users 134A-N can be individuals, organizations, or automated systems that send informational messages to recipients such as reminders, appointment confirmations, account information, or any other type of information. End-users 134A-N can be customers of customer platform 130. End-users 134A-N can also or alternatively be direct customers of communication services platform 120. End-users 134A-N can communicate with communication services platform 120 and/or customer platform 130 via APIs 122 and/or 132.

Messaging platforms 140A-N can be associated with respective communication channels and can be entities or platforms that route messages from senders to recipients (or vice versa) via the respective communication channels. Examples of messaging platforms include telecommunication providers (e.g., cellular carriers), instant messaging platforms (e.g., WhatsApp, Facebook Messenger), email providers and others. Analogous to API 122, messaging platforms 140A-N (or associated messaging platforms) can provide APIs 142A-N for interacting with one or more services provided by messaging platforms 140A-N. For example, APIs 142A-N can be used to create sender accounts and/or send messages. APIs 142A-N can be used by other platforms in various embodiments, such as communications services platform 120, customer platform 130, and/or end-users 134A-N. Messaging platforms 140A-N include respective sets of sender accounts 144A-N that can be used for sending messages with messaging platforms 140A-N. As described herein, sender accounts 144A-N can have different configuration requirements and procedures for different messaging platforms, and can be configured by communication services platform 120.

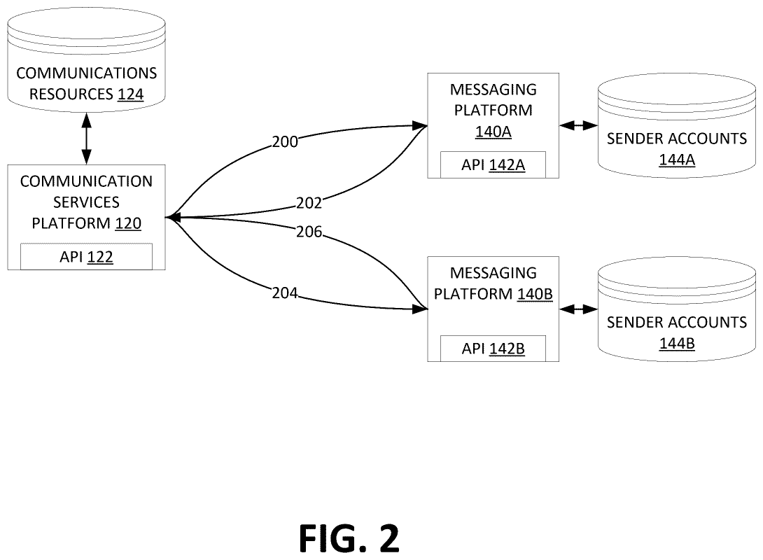

FIG. 2 is a block diagram of communication services platform 120 communicating with messaging platforms 140A-B (each associated with a respective messaging channel) over a plurality of communication channels 200-206 to configure sender accounts, in accordance with an embodiment. Communication services platform 120 can initiate sender configuration for messaging platform 140A using communication channel 200 or another communication channel not depicted. For example, communication services platform 120 can initiate sender configuration using API 142A. Messaging platform 140A can send a verification message over communication channel 202, which can be associated with one of communications resources 124. A verification message can include a code that is to be sent back to the messaging platform by the communication services platform to prove that the communication services platform is in possession of the communications resource. Similarly, a verification message can include a set of instructions to be followed to prove that the communication services platform is in possession of the communications resource (e.g., an instruction to send an acknowledgement response). Communication services platform 120 can provide the verification message (or an appropriate response to the verification message, such as an acknowledgement response) back to messaging platform 140A over communication channel 200. Similarly, communication services platform 120 can initiate sender configuration for messaging platform 140B using communication channel 204 or another communication channel not depicted. For example, communication services platform 120 can initiate sender configuration using API 142B. Messaging platform 140B can provide a verification message over communication channel 206, which can be associated with one of communication resources 124. Communication services platform 120 can provide the verification message (or an appropriate response to the verification message, such as an acknowledgement response) back to messaging platform 140B over communication channel 204.

In an embodiment, communication channels 200 and 204 are the same communication channel. For example, both communication channels can be associated with APIs. In an embodiment, channels 200 and 204 are different communication channels. Similarly, communication channels 202 and 206 can be the same or different communication channels in various embodiments. For example, both can be SMS communication channels, or one can be an SMS communication channel and the other can be an email communication channel.

In an embodiment, communication channels 200 and 202 are different communication channels. For example, 200 can be an API communication channel and communication channel 202 can be an SMS communication channel. In an embodiment, communication channels 200 and 202 can be the same communication channel. For example, both communication channels can be SMS communication channels. In this example, the verification message can be a prompt and communication services platform 120 can respond with an affirmative message such as “YES,” “CONFIRM,” etc. Similarly, communication channels 204 and 206 can be the same or different communication channels in various embodiments.

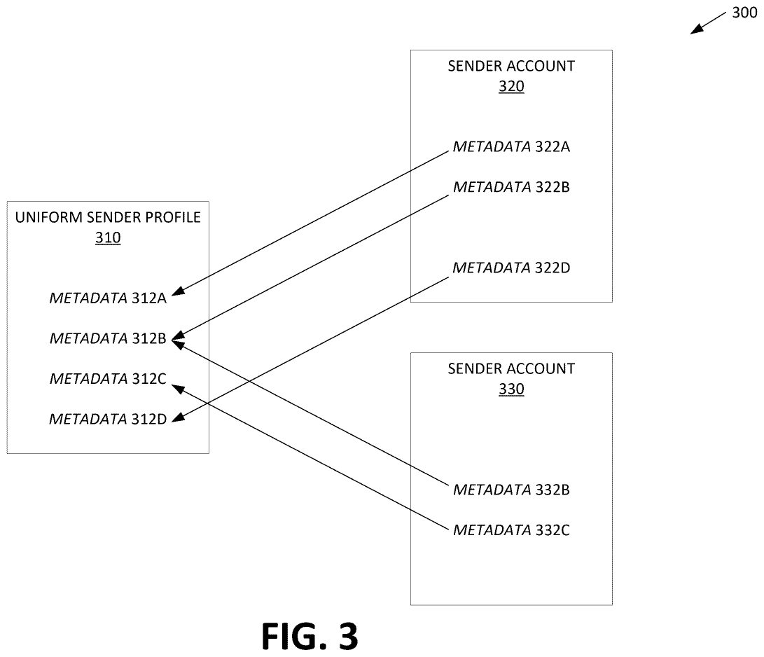

FIG. 3 illustrates a mapping 300 of message platform-specific sender account data structures to a uniform sender profile data structure of a communication services platform, in accordance with an embodiment. Uniform sender profile 310 and sender accounts 320 and 330 include respective metadata 312A-D, 322A-B-D, and 333B-C. In an embodiment, metadata can refer to customer information such as customer name, phone number, email address, other identifiers, KYC data, or similar. In an embodiment, metadata can refer to messaging channel information such sender status, quality metrics, message counts and limits, or similar. Mapping 300 can be used by the communication services platform to determine metadata to be provided to messaging platforms when creating sender accounts based on metadata that has been provided to the communication services platform by a customer.

Metadata of different sender accounts can conform to different schemas. For example, sender account 320 includes metadata 322A-B-D, while sender account 330 only includes metadata 322B-C. Uniform sender profile can include a metadata schema that is a superset of the schemas of sender accounts 320 and 330, such that a mapping can be made between metadata in sender accounts 320 and 330 and metadata in uniform sender profile 310. For example, uniform sender profile 310 includes metadata 312A-D.

FIG. 4 is a flow diagram of an example method 400 for creating sender accounts for messaging channels, in accordance with an embodiment. Method 400 may be performed by processing logic that may comprise hardware (e.g., circuitry, dedicated logic, etc.), computer-readable instructions such as software or firmware (e.g., run on a general-purpose computing system or a dedicated machine), or a combination thereof. For instance, an example system may include a memory and a processing device coupled to the memory device to perform operations comprising the blocks of method 400. Method 400 may also be associated with a set of instructions stored on a non-transitory computer-readable medium (e.g., magnetic or optical disk, etc.). The instructions, when executed by a processing device, may cause the processing device to perform operations comprising the blocks of method 400. In an embodiment, method 400 is performed by communication services platform 120 of FIG. 1. In an embodiment, method 400 is performed by computing system 500 of FIG. 5. In some embodiments, blocks depicted in FIG. 4 could be performed simultaneously or in a different order than depicted. Various embodiments may include additional blocks not depicted in FIG. 4 or a subset of blocks depicted in FIG. 4.

At block 402, processing logic of a communication services platform receives a first request of a customer to create a sender account associated with at least a first messaging channel of a plurality of messaging channels. The communication services platform can be communication services platform 120 of FIG. 1. The customer can be customer platform 130. The first messaging channel can be associated with one of messaging platforms 140A-N. The sender account can be stored with corresponding sender accounts 144A-N. In an embodiment, the first messaging channel is one of: an instant messaging channel, an RCS channel, an SMS/MMS channel, a voice messaging channel, or an electronic mail messaging channel. In an embodiment, the first request is received via an API implemented by the communication services platform (e.g., API 122).

In an embodiment, the first request can comprise information associated with the customer (e.g., customer metadata), such as a customer identifier, a name of the customer, a URL identifying a website of the customer, one or more data items of a KYC profile, or similar. In an embodiment the information associated with the customer can be provided to the communication services platform in one or more separate communications and/or can be stored by the communication services platform.

At block 404, the processing logic transmits, via a first communication channel, to a first messaging platform associated with the first messaging channel, a second request to create the sender account, wherein the second request comprises an identifier of a communication resource associated with the communication services platform. The communication resource can be one of communication resources 124, such as an email address (e.g., of a plurality of email addresses) or a phone number (e.g., of a plurality of phone numbers) that the communication services platform can use to receive messages. In an embodiment, the second request is transmitted via a sender account configuration request API call implemented by the first messaging platform. The API can be one or APIs 142A-N. In an embodiment, the second request further comprises one or more of: a name of the customer, a URL identifying a website of the customer, or one or more data items of a KYC profile of the customer.

At block 406, the processing logic receives, via a second communication channel associated with the communications resource, a verification message. The second communication channel can be, e.g., a voice message or SMS message associated with a phone number, or an email message associated with an email address. In an embodiment, the verification message comprises a one-time password, which can be a string of alphanumeric digits, an image such as a QR code, an audio-based code, a unique URL, or similar. In an embodiment, the verification message can be a key for generating a time-based one-time password or similar. In an embodiment, the verification message can be a challenge question or similar.

At block 408, the processing logic transmits the verification message, via the first communication channel to the first messaging platform. For example, the processing logic can use an API of the messaging platform to communicate the verification message. In an embodiment, the processing logic communicates a second verification message associated with the verification message, such as a time-based one-time password or an answer to a challenge question. In an embodiment, the processing logic communicates the verification message via a third communication channel, such as sending a request to a URL indicated in the verification message.

At block 410, the processing logic notifies the customer of a result of creating the sender account. For example, the processing logic can return a result via an API indicating that configuration of the sender account was successful, was unsuccessful, is in progress, or similar.

At block 412, the processing logic utilizes the sender account for forwarding messages originated by one or more users associated with the first customer. The messages can be originated by one or more of end-users 134A-N. The messages can be forwarded by the first messaging platform to one or more of recipient devices 150A-N.

In an embodiment, one or more of blocks 402-412 can be repeated for creating or configuring a second sender account associated with the first messaging platform or a second messaging platform and for sending messages using the second sender account. The first request of block 402 can be associated with a same or similar format for both the first sender configuration and the second sender configuration (e.g., both first requests can use the API). The second request of block 404 can be associated with different formats for the first sender configuration and the second sender configuration (e.g., each second request can use a different API associated with a different messaging platform).

FIG. 5 is a block diagram illustrating an example computer system 500, in accordance with implementations of the present disclosure. Computer system 500 may correspond to platforms 120, 130, 134A-N, or 140A-N, or to recipient devices 150A-N, as described above with reference to FIG. 1. Computer system 500 may operate in the capacity of a server or an endpoint machine in endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 500 includes processing device 502 (e.g., one or more processors or cores), main memory 504 (e.g., read-only memory (ROM), flash memory, dynamic random access memory (DRAM) such as synchronous DRAM (SDRAM), double data rate (DDR SDRAM), or DRAM (RDRAM), etc.), static memory 506 (e.g., flash memory, static random access memory (SRAM), etc.), and data storage device 508, which communicate with each other via bus 510.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. Processing device 502 is configured to execute instructions 512 (e.g., for storing contextual data with context schemas) for performing the operations discussed herein.

Computer system 500 may further include network interface device 514. Computer system 500 also may include display device 516 (e.g., a liquid crystal display (LCD) or a cathode ray tube (CRT)), alphanumeric input device 518 (e.g., a keyboard, and alphanumeric keyboard, a motion sensing input device, touch screen), cursor control device 520 (e.g., a mouse), and signal generation device 522 (e.g., a speaker). In some embodiments, computer system 500 may not include display device 516, alphanumeric input device 518, and/or cursor control device 520 (e.g., in a headless configuration).

Data storage device 508 may include a non-transitory machine-readable storage medium 524 (also computer-readable storage medium) on which is stored one or more sets of instructions 512 (e.g., for storing contextual data with context schemas) embodying any one or more of the methodologies or functions described herein. Instructions 512 may also reside, completely or at least partially, within main memory 504 or within the processing device 502 during execution thereof by computer system 500, main memory 504 and processing device 502 also constituting machine-readable storage media. Instructions 512 may further be transmitted or received over network 526 via network interface device 514.

In one implementation, instructions 512 include instructions for storing contextual data with context schemas, as described herein. While computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method comprising:
receiving, by a communication services platform, a first request of a customer to create a sender account associated with a first messaging channel of a plurality of messaging channels;
transmitting, via a first communication channel, to a first messaging platform associated with the first messaging channel, a second request to create the sender account, wherein the second request comprises an identifier of a communication resource associated with the communication services platform;
receiving, via a second communication channel associated with the communication resource, a verification message;
transmitting the verification message via the first communication channel to the first messaging platform; and
notifying the customer of a result of creating the sender account.

2. The method of claim 1, wherein the second request further comprises one or more of: a name of the customer, a URL identifying a website of the customer, or one or more data items of a know-your-customer (KYC) profile of the customer.

3. The method of claim 1, wherein the first request is received via an application programming interface (API) implemented by the communication services platform.

4. The method of claim 1, wherein the second request is transmitted via a sender account configuration request API call implemented by the first messaging channel.

5. The method of claim 1, further comprising: utilizing the sender account for forwarding messages originated by one or more users associated with the customer.

6. The method of claim 1, wherein the first messaging channel is one of: an instant messaging channel, a rich communication services (RCS) channel, an SMS/MMS channel, a voice messaging channel, or an electronic mail channel.

7. The method of claim 1, wherein the communication resource is one of: an electronic mail address or a phone number.

8. The method of claim 1, wherein the verification message comprises a one-time password.

9. A system comprising:
a memory device; and
a processing device coupled to the memory device, the processing device to perform operations comprising:
receiving, by a communication services platform, a first request of a customer to configure a sender account associated with at least a first messaging channel of a plurality of messaging channels;
communicating, to the first messaging channel via a first communication channel, a second request to configure the sender account, wherein the second request comprises an identifier of a communication resource associated with the communication services platform;
receiving, via a second communication channel associated with the communication resource, a verification message;
communicating, to the first messaging channel via the first communication channel, the verification message; and
notifying the customer of a result of configuring the sender account.

10. The system of claim 9, wherein the second request further comprises one or more of: a name of the customer, a URL identifying a website of the customer, or one or more data items of a know-your-customer (KYC) profile of the customer.

11. The system of claim 9, wherein the first request is received via an application programming interface (API) implemented by the communication services platform.

12. The system of claim 9, wherein the second request is transmitted via a sender account configuration request API call implemented by the first messaging channel.

13. The system of claim 9, the operations further comprising: utilizing the sender account for forwarding messages originated by one or more users associated with the customer.

14. The system of claim 9, wherein the first messaging channel is one of: an instant messaging channel, a rich communication services (RCS) channel, an SMS/MMS channel, a voice messaging channel, or an electronic mail channel.

15. A non-transitory computer-readable medium comprising instructions that, when executed by a processing device, cause the processing device to perform operations comprising:
receiving, by a communication services platform, a first request of a customer to configure a sender account associated with at least a first messaging channel of a plurality of messaging channels;
communicating, to the first messaging channel via a first communication channel, a second request to configure the sender account, wherein the second request comprises an identifier of a communication resource associated with the communication services platform;
receiving, via a second communication channel associated with the communication resource, a verification message;
communicating, to the first messaging channel via the first communication channel, the verification message; and
notifying the customer of a result of configuring the sender account.

16. The non-transitory computer-readable medium of claim 15, wherein the second request is transmitted via a sender account configuration request API call implemented by the first messaging channel.

17. The non-transitory computer-readable medium of claim 15, the operations further comprising: utilizing the sender account for forwarding messages originated by one or more users associated with the customer.

18. The non-transitory computer-readable medium of claim 15, wherein the first messaging channel is one of: an instant messaging channel, a rich communication services (RCS) channel, an SMS/MMS channel, a voice messaging channel, or an electronic mail channel.

19. The non-transitory computer-readable medium of claim 15, wherein the communication resource is one of: an electronic mail address, or a phone number of a plurality of phone numbers.

20. The non-transitory computer-readable medium of claim 15, wherein the verification message comprises a one-time password.
